(19) United States
(12) Patent Application Publication
(10) Pub. No.: US 2019/0022854 A1
(43) Pub. Date: Jan. 24, 2019

(54) WORKING DEVICE THAT IS AUTOMATICALLY MOVABLE OUTDOORS

(71) Applicant: Vorwerk & Co. Interholding GmbH, Wuppertal (DE)

(72) Inventors: Georg HACKERT, Bochum (DE); Martin HELMICH, Duisburg (DE); Lorenz HILLEN, Wuppertal (DE); Christian HOLZ, Dortmund (DE); Gerhard ISENBERG, Koeln (DE); Hendrik KOETZ, Wetter (DE); Andrej MOSEBACH, Bochum (DE); Roman ORTMANN, Duisburg (DE); Robin DULINSKI, Wuppertal (DE)

(73) Assignee: Vorwerk & Co. Interholding GmbH, Wuppertal (DE)

(21) Appl. No.: 16/042,168

(22) Filed: Jul. 23, 2018

(30) Foreign Application Priority Data
Jul. 24, 2017 (DE) 10 2017 116 659.9

(51) Int. Cl. B25J 9/16; G05D 1/02; B25J 19/00; B25J 9/00; B64C 39/02; B64D 47/08

(52) U.S. Cl. CPC B25J 9/161; G05D 1/0274; G05D 1/0246; B25J 19/005; A01D 34/008; B25J 9/1697; B25J 9/0003; B64C 39/024; B64D 47/08; B25J 9/1674

(57) ABSTRACT

A working device that can move self-sufficiently over terrain, which carries task-specific tools. The tools are allocated to different working modules. The different working modules can optionally be used by the working device. The working modules can be a watering tool, a cutting tool, a mowing tool, a sweeping tool, a fertilizer distributing tool or a soil treating tool. The plants are processed with the help of a planning aid which has a database. The planning aid is used to transmit task data to the working device.

### CROSS REFERENCE TO RELATED APPLICATIONS

Applicant claims priority under 35 U.S.C. § 119 of German Application No. 10 2017 116 659.9 filed Jul. 24, 2017, the disclosure of which is incorporated by reference.

### BACKGROUND OF THE INVENTION

### 1. Field of the Invention

The invention relates to a working device that is automatically movable outdoors, which can be moved with the help of a chassis that is controlled by sensor data obtained without contact by a control device using a sensor array and possibly by a cartography stored in a storage element, and which can be navigated by the control device at locations of a terrain where a task is to be performed, for which task-specific tools allocated to the working device are used.

### 2. Description of the Related Art

Such working tools are known in the art, for example as self-propelled lawnmowers. Known in particular from EP 2 423 893 are sweeping robots usable indoors in the form of self-propelled devices having tools for cleaning.

### SUMMARY OF THE INVENTION

The object of the invention is to indicate an autonomous outdoor device that can perform plant care tasks, in particular automatically.

The object is achieved with the invention indicated in the claims.

According to the invention, the working device is further developed in such a way that the tools are allocated to a tool-specific work module. The working modules can optionally be connected with the working device. They are allocated to the working device, and can be replaced with another working module. To this end, the working device can have a module carrier for receiving the working module. The working device can be fitted with a respective working module, whose tool is intended to master a specific task, in particular a plant care task. The tasks can be individually given to the working device by the user. The user can do this with a data communication device, e.g., a personal computer, a mobile terminal device (cell phone, smartphone) or a tablet computer. The working device has a transmitting/receiving device, so as to communicate directly with the data communication device. However, it can also communicate with the data communication device via a data transmission device in the form of a network. It is further provided that the sensor array be used not just to navigate the working device, but also for detecting environment parameters relating to the plants to be cared for. For example, it is provided in particular that the sensors can detect the current air temperature, air moisture, UV radiation, brightness and/or soil moisture. The working device can be set up in such a way as to automatically go on investigatory runs, during which the working device uses the sensors, which in particular comprise imaging sensors, such as a camera, to determine the current growth status of plants to be cared for. Structure data for the environment currently recorded with the camera can be compared with older data, so as to offer suggestions to the user about potentially required care work. Information specific to the season is here also taken into account, for example information that provides data about the most favorable cutting times or prohibited cutting times. It is further provided that the working device interact with a planning aid, which utilizes a database used in an external computing device, which stores care information for care data having plants. The working device is preferably able to communicate with the database via a data transmission device. This data transmission device can be a network. The computing device is here set up in such a way as to generate task data from the care data, which are transmitted to the working device or to the data communication device of the user. The care data contain location-specific data for the job site. Involved here are landscape- and garden-specific information, along with information about the tools present at the job site. It is further provided that the care data be automatically maintained by the working device, specifically by having the working device transmit the current condition data obtained with its sensor array to the computing device. The condition data can then be used for calculating the task data. The task data can involve watering instructions, cleaning instructions or cutting instructions for the plants. These task data are transmitted to the working device, which then fits its module carrier with the working module required for handling the task. The modules optionally securable to the working device can be supplied at the location of the base station, or a respective weatherproof housing or shed can be provided on the base station. A detachable connection exists between the module and working device. To this end, the working device can have a module carrier with a correspondingly standardized design. The module can be fastened to the module carrier by means of mechanical retaining means. This mechanical retaining means is detachable, so as to remove the module from the module carrier and replace it with another module. Further provided is an electrical interface between the module and module carrier. The electrical interface can be a plug connection. A supply voltage can be transmitted from the module carrier to the module via the electrical interface. It is further provided that data can be exchanged between the working device and module via the electrical interface. If a module has an accumulator, it can also be provided that the working device be supplied with power by this accumulator via the electrical interface. The cartography stored in the working device contains information about the location of the base station and/or repository for the working modules. The cartography further contains information about the location of the plants to be cared for and what kinds of plants are planted there. This case can involve the two-dimensional surface data of a base mapping that were enhanced using sensor data recorded with a sensor module to yield 3D data, which contain growth heights of the plants, and in particular a volume model for individual plants or a plant arrangement. It is further provided that the working device interact with one or several additional sensor modules. The sensor module can involve a self-propelled sensor module, which only comprises one or several of the aforementioned sensors, with which physical features of objects in the environment can be detected from varying perspectives, and environment data and in particular structure data can be determined for the plants. The sensor module can also be used to determine the local soil moisture or to image the environment. In particular, the additional sensor module is provided for acquiring environment structure data from another perspective, so that either the external computing device or the control device of the working device can generate a three-dimensional image of the environment. Based on this in particular three-dimensional environment image, the external computing device or the control device of the working device can then, in particular through comparison with older, in particular three-dimensional images, decide whether one or several growths must be cut. The specific cutting process can then be performed with cutting tools. A soil moisture sensor can be used to determine the soil moisture. If the soil moisture is too low, a watering module can be used for watering purposes. To this end, the watering module can have a water tank. However, it can also be connected with a hose having a tap. Additional working devices can be used, for example a mowing tool, a sweeping tool, a fertilizer distributing tool or a soil treating tool. The sensor array of the sensor module and/or working device can further be designed in such a way as to ascertain environment structure data which can be used to decide whether cleaning has to take place. For example, the degree to which the subsoil is covered with leaves can be determined in autumn. A sweeping device can then be used to remove the leaves that accumulated on lawn areas or other open areas, for example. The snow depth can be measured in winter, and the snow can be cleared from prescribed surfaces. The sensor module can be a self-propelled vehicle. However, it can also be moved by the working device itself, and dropped off at a prescribed location, where it uses its sensor array to determine condition data for the environment. The sensor module can also be permanently installed, and is in particular connected by way of a data transmission device with the working device, a base station or an external computing device. As with the working device itself, the sensor module can have an accumulator, which powers the sensors of the sensor module or working device. It is also provided that the sensor module or working device have a self-sufficient energy supply, for example an integrated photovoltaic system. However, it is also possible to connect the sensor module with a power supply network. In particular, one or several sensor modules can use the sensor array of the working device or their own sensor array to detect the spatial surroundings of the pending assignment. The assignment for the working device itself can also be controlled by the sensors of the at least one sensor module. Communication, in particular wireless communication, takes place between the working device and sensor module here as well. The sensor array of the at least one sensor module monitors the operation of the working device, in particular from different perspectives. Once the assignment has been completed, the working device can bring a non-stationary sensor module back to the base station or some other storage device. The working device can have grippers or other aids for holding the sensor module or one of the other working modules. The sensor module can also be designed as a self-sufficient robot. The sensor robot can automatically navigate the terrain, and in particular travel on the soil. It here uses a cartography of the terrain. The working device can provide the sensor robot with the cartography. However, it is also possible for the external computing device to provide the cartography. An alternative embodiment of the sensor module provides that the sensor module be able to fly. For example, it can be fixedly positioned at a point above the assignment, i.e., above a plant to be cared for, via a GPS-supported navigation system, so as to transmit environment data to the working device. The sensor module designed as a drone also makes it possible to completely three-dimensionally capture the object to be cared for, e.g., a tree, with a built-in camera without the use of additional sensors, by making several images of the object to be cared for, e.g., the tree, from different perspectives, out of which a computing device generates a three-dimensional model. The images are stored in the computing device, and in particular in the database, as a volume model of a plant or plant group. A current volume model documenting the actual condition can be compared with a volume model generated at an earlier time, so as to determine a growth height or arrive at a decision as to whether the plant must now be cut.

### BRIEF DESCRIPTION OF THE DRAWINGS

The invention will be explained below based on the attached drawings. Shown on:

FIG. 1 is a terrain with plants 8, 8′, a working device 1 for plant care, a sensor module 9 for acquiring plant data, and an external computing device 15 for communicating 14 with a plurality of working devices 1 and/or data communication devices 17.

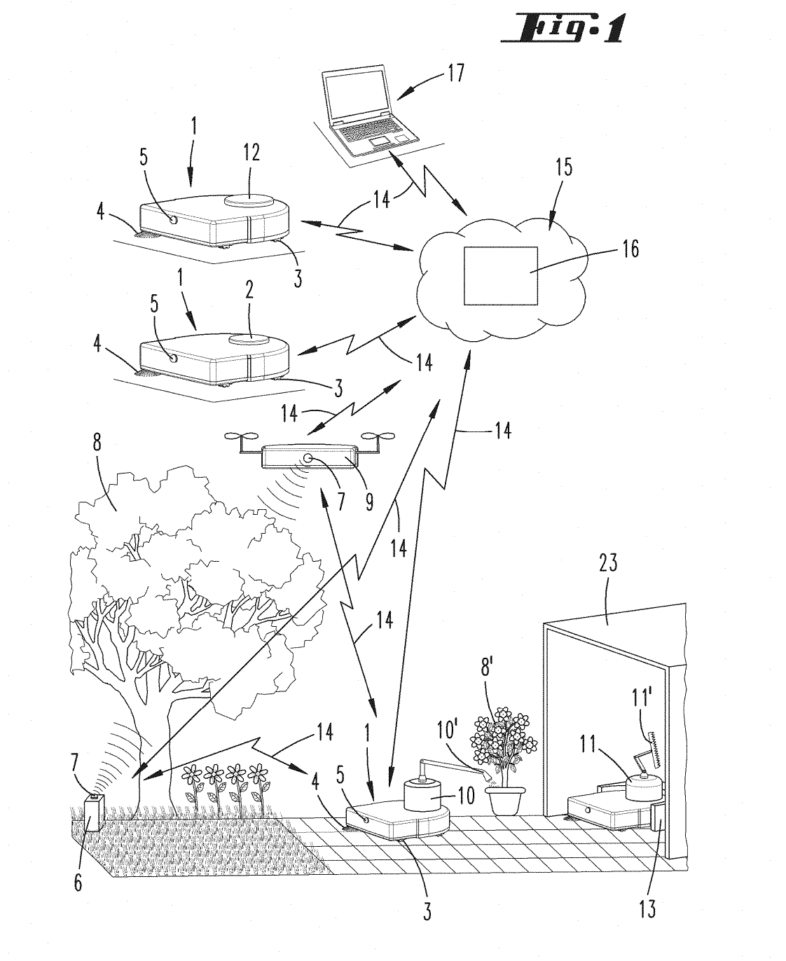

FIG. 2 is a schematic view of a working device 1, a base station 13 and the communication paths used to communicate with an external computing device 15.

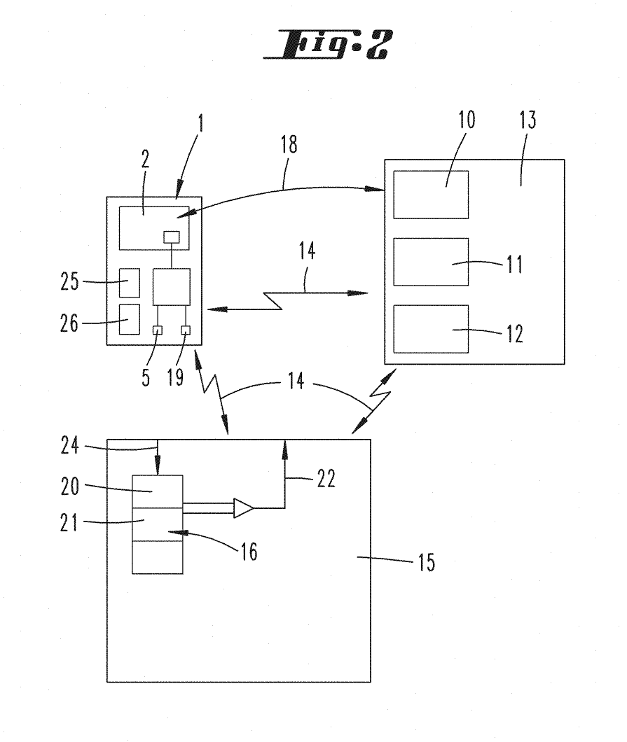

### DETAILED DESCRIPTION OF THE PREFERRED EMBODIMENTS

The invention relates to devices and methods, as well as to a system for garden care. The essential system components include at least one working device 1, one or several working modules 10, 11, and an external computing device 15, which can communicate with the working device 1 via a data transmission device 14, which can be a home network or the internet.

The working device 1 has a housing, and inside of the housing a chassis 3, which can have wheels, chain drives, or even one or several propellers, with which the working device 1 can be moved in the outdoor area, outside of buildings, in a garden, and possibly even in the air. It has a control device 12, which can be a microcontroller or some other program-controlled computing device with peripheral storage.

Sensors 5 are provided, which the control device 12 can use to acquire structure data for the environment, e.g., the shape and size of objects, plants, but also humans and animals. These data initially serve to navigate the working device 1 on the terrain. The storage elements of the control device 12 can additionally store a cartography for the terrain, which contains lawn areas, crop and ornamental plant beds, trees, paths or other permanent structure data for the environment, based on which the working device 1 can automatically navigate the terrain. The sensors 5 further also comprise sensors for acquiring condition data for the environment that change over time, in particular for the plants. For example, a camera can be used to obtain an image of the plants. A moisture sensor can be used to determine the humidity or soil moisture. A UV sensor can be used to determine the current UV radiation. A thermometer can be used to measure the soil temperature and/or air temperature. A brightness sensor can be used to determine the current brightness. In particular, it is provided that a three-dimensional cartography be prepared, wherein this cartography contains the location and height of individual plants, individual plant groups, buildings or other objects. In particular, the three-dimensional cartography also contains the type of plants and zones that must not be traversed by the ground vehicle. The cartography can further contain storage locations for working tools, such as vehicles and working modules or sensor modules. The three-dimensional cartography can be generated based on a two-dimensional cartography, wherein the two-dimensional cartography was generated by a user with measuring equipment or with images. The environment can be acquired by the sensors 5, so as to enhance the 2D cartography.

A transmitting/receiving device 19 is provided, which enables wireless communication in particular via the data transmission device 14. The transmitting/receiving device 19 can communicate directly with a base station 13, which is fixedly arranged on the terrain, and whose position in the cartography of the working device 1 is recorded. However, the data transmission device 14 can also be set up in such a way that the working device 1 can communicate directly with a home network of the internet.

In addition, the working device 1 has an accumulator 25, which when the working device 1 is on the base station 13 can be changed, and which otherwise supplies the working device 1 with electrical energy.

The working device 1 has a mechanism for receiving working modules 10, 11, which carry module-specific tools 10′, 11′. This mechanism is referred to as a module carrier 2 below, and is designed in such a way that the working device 1 can automatically change out one working module 10 for another working module 11. This preferably takes place on the base station 13 or in the area of a storage feature, for example a shed 23, in which the working modules 10, 11 are stored, protected against the weather. Means not shown in the drawings can there be provided, e.g., grippers or the like, with which the working modules 10, 11 can be fixed onto the module carrier 2. The module carrier 2 can have a module interface 18, with which a signal connection and power connection with the working module 10 can be established.

The module carrier 2 has a mechanical interface (not shown) and an electrical interface (not shown). The working modules 10, 11 or potentially present sensor modules also have a mechanical interface and an electrical interface. The two mechanical interfaces interact in such a way that they mechanically bind the working module 10 or sensor module to the module carrier 2. These can here be hooks, screw connections or other types of latching connections, which can be moved from a bound position into a released position. The electrical interface can be used to transmit electrical energy from the working device 1 to the working module 10, 11. However, it is also possible to transmit electrical energy from the working module 10, 11 to the working device 1. It is further provided that data be exchanged between the working device 1 and working module 10, 11 via the electrical interface. The electrical interface can be a plug connection. To this end, the plug and mating plug engage into each other, so as to establish electrical contact with each other.

The drawings only exemplarily show a working module 10 in the form of a watering module, which has a watering tool 10′. The watering module 10 can have a tank for storing water, which can be filled at the base station 13. However, it is also possible for the watering module 10 to be connected with a hose to get water from a tap.

Reference number 11 denotes a cutting module, which has cutting tools 11′, which can be used to cut the plants. The cutting tool 11′ can be a pair of scissors or a mower, for example. In particular, it can be a hedge trimmer or pruning shears, which can be used to cut hedges, trees or other growths. Also provided are working modules with special tools for spreading fertilizer, raking leaves, clearing snow or loosening soil.

In addition, sensor modules 6 can be provided that are set up in a stationary manner on the terrain, or positioned by the working device 1 at a suitable location on the terrain so as to be deployed in completing the respective task. However, the sensor module can also be self-propelled, and automatically navigate to a location. For example, a working device 1 can for this purpose carry a sensor module instead of a working module 10, 11.

One variant provides that the sensor module 9 be a flying sensor robot. This drone has one or several propellers, and a GPS controller or the like allows it to assume predetermined positions in the airspace above the terrain, so as to acquire condition data at various positions.

Sensors 5, 7 of the working device 1 or sensor module 6, 9 preferably involve imaging sensors, e.g., a camera, which can be used to record two-dimensional images. The control device 12 or external computing device 15 can calculate three-dimensional structure data for the environment from these two-dimensional images. The sensors 5, 7 also have temperature sensors for determining the soil temperature and/or air temperature, moisture sensors for determining the soil moisture and/or humidity, UV sensors or brightness sensors. It is provided that the working device 1 and/or sensor module 6, 9 have at least one, but preferably a plurality, of these sensors.

The sensor data obtained by these sensors 5, 7 are optionally transmitted wirelessly to an external computing device 15 using the data transmission device 14.

In an aspect of the invention, the external computing device 15 is operated at a spatial distance, in particular from an external server. However, it can also consist of a local computer. The external computing device 15 can communicate with a plurality of working devices 1, which are operated at various locations. The external computing device 15 is further able to communicate with one or several data communication devices 17 kept on standby at various locations, wherein the data communication devices 17 can be mobile terminal devices, personal computers or tablet computers and the like. A plurality of users and in particular members of a user group can use these data communication devices 17 to enter empirical values and data about specific areas of the terrain to be cared for. Cartographies can here also be transmitted, wherein the cartographies are recorded during exploratory trips of the working device 1. The data communication devices 17 can further be used to enter data about the positions and type of specific plants on the respective terrain.

The external computing device 15 has a database 16, which stores plat care information. The care information contains in particular plant-specific care tasks, e.g., information about the optimal seasons for plant pruning, whether the plants are shedding leaves, which soil moistures are optimal for the plants, etc. The care information thus contains in particular watering information, cutting information and cleaning information. The database 16 further stores location-specific data, which are specific to the user, and in particular contain the cartography of the terrain to be cared for. In addition, the location-specific data can consist of the location data for the plants, information about present working modules 10, 11, current weather information and plant heights. Legal requirements can also be stored in the database.

The current weather information, plant heights, soil moisture and humidity, etc., are currently obtained by the sensors 5, 7 of the working devices 1 or sensor modules 6, 9. These condition data 24 are made available to the external computing device 15 by the data transmission device 14, and there stored.

The computing device 15 is able to calculate task data 2 from the care data, i.e., from the location-specific data 20 and care information 21, in particular drawing upon the current condition data 24. These task data 22 contain tasks that are currently to be performed on the terrain, so as to care for the plants. For example, the task data 22 can contain information about the location where plants must be watered, or about which plants must be cut at what position. The task data can further contain information as to whether a lawn must be mowed or whether leaves must be removed from an area. To this end, shoot height data are also computed from the height and volume data.

Just as the condition data 24 are obtained with the sensors of the working device or sensor modules 6, 9, these sensors 5, 7 can be used for self-sufficient task completion on the terrain. To this end, the sensor modules 6, 9 are moved into an optimal position for acquiring the structure data, e.g., so as to generate a 3D image of the plant to be cared for with their cameras. These structure data are then used to control the tools 10′, 11′ of the working modules 10, 11.

The external computing device 15 can additionally have a knowledge database, in which users can enter their personal experiences or with which users can ask members of the user groups questions. As a consequence, the external computing device 15 provides a communication platform similar to a social media platform, which can serve as a meeting place for users of such an autonomous outdoor device. This platform and in particular applications connected to this platform can be used to prepare empirical values of individual users for the totality of all users, and make them available to the community, e.g., in the form of tips, application suggestions or aids. For example, the user communicates with this communication platform via a control device, e.g., a control device of the autonomous outdoor device. Communication via a mobile terminal device, a tablet PC and in particular an internet connection is likewise provided. Also provided is that the autonomous working device 1 or one of the sensor modules 6, 9 have a touch-sensitive screen, which can be used to communicate with the external computing device 15.

The knowledge database can also be used to make recommendations for action based on tips or empirical data stored by the user in the database, with which the growth of individual plants can be optimized.

### REFERENCE LIST

1 Working device
2 Module carrier
3 Chassis
4 Sweeping device
5 Sensor
6 Sensor module
7 Sensor
8 Plant
8′ Plant
9 Drone
10 Working module
10′ Tool
11 Working module
11′ Tool
12 Control device
13 Base station
14 Data transmission device
15 Computing device
16 Database
17 Data communication device
18 Module interface
19 Transmitting/receiving device
20 Data
21 Care information
22 Task data
23 Shed
24 Condition data
25 Accumulator
26 Communication interface

What is claimed is:

1. A working device that is automatically movable outdoors, comprising:
a chassis,
a control device configured for controlling the chassis, wherein the control device uses control data obtained by sensors of a sensor array and a cartography stored in a memory element, for navigating the working device at locations of a terrain where a task is to be performed,
task-specific tools allocated to a working module that is allocated to the working device, so as to be replaceable with another working module with other tools,
wherein the working device is designed to exchange data with a planning aid, which interacts with a database of an external computing device that stores care information for plant data having plants, from which task data are generated and transmitted to the working device, and/or
wherein the working device is configured to interact with a sensor module, which uses a sensor array to acquire structure data for plants to be cared for, wherein the sensor module is an external sensor module designed separately from the working device.

2. The working device according to claim 1, wherein the working device has a module carrier for receiving the working module.

3. The working device according to claim 1, wherein the working module has a watering tool, a cutting tool, a mowing tool, a sweeping tool, a fertilizer distributing tool or a soil treating tool.

4. The working device according to claim 1, wherein the working device is configured to interact with a base station, on which one or several working modules are kept on standby.

5. The working device according to claim 1, further comprising a communication interface that is configured to communicate with the external computing device.

6. A module configured for use on a working device according to claim 1, and a module carrier, wherein the module has a mechanical retainer and an electrical plug, which together with a mechanical counter-retainer and a mechanical counter-plug of the module carrier form a detachable mechanical interface and/or a detachable electrical interface, wherein the mechanical interface detachably binds the module to the module carrier, and data and/or electrical energy are transmitted via the electrical interface.
